(19) United States
(12) Patent Application Publication
(10) Pub. No.: US 2020/0343748 A1
(43) Pub. Date: Oct. 29, 2020

(54) POWER CARRYING CASE

(71) Applicant: Oxti Corporation, Taipei (TW)

(72) Inventor: Chih Feng HO, Taipei (TW)

(21) Appl. No.: 16/395,290

(22) Filed: Apr. 26, 2019

(51) Int. Cl. H02J 7/00; H02J 7/02

(52) U.S. Cl. CPC H02J 7/0045; H02J 2007/0059; H02J 7/025; H02J 7/0052

(57) ABSTRACT

A power carrying case includes a housing having an input terminal, and one or more output terminals, an electric charging circuit disposed in the housing and electrically connected to the input terminal of the housing, the electric charging circuit includes a battery electrically connected to the output terminal, an electric cable is used for electrically connecting to the input terminal of the housing, and one or more electric charging mechanisms electrically connected to the battery. The housing includes a channel for receiving the electric charging mechanism. The housing includes one or more handles for being grasped and held by the user.

### BACKGROUND OF THE INVENTION

### 1. Field of the Invention

The present invention relates to a portable converter hub assembly or electric power source or power carrying case, and more particularly to a portable electric power source or power carrying case including an improved compact structure or configuration for being easily carried with the user and for being easily actuated or operated by the user.

### 2. Description of the Prior Art

Typical converter hub assemblies or electric power source or carrying cases comprise a housing or receptacle including a chamber or compartment formed therein for receiving or storing various electric circuit boards or parts or elements therein, and including a number of ports or terminals or connectors for electrically connecting or coupling to various electrical facilities or implements.

For example, U.S. Pat. No. 8,203,237 B1 to Cowles, U.S. Pat. No. 9,237,217 B2 to Zeung et al., U.S. Pat. No. 9,490,659 B1 to English et al., U.S. Pat. No. 9,543,770 to O'Keefe et al., U.S. Pat. No. 9,864,421 B2 to Li et al., and U.S. Pat. No. 9,997,939 B2 to Li disclose several of the typical converter hubs or electric power source or power carrying cases each comprising a container having one or more ports or terminals or connectors for electrically connecting or coupling to various electrical facilities or implements.

However, the typical converter hubs or electric power source or power carrying cases may not be easily carried with the user and for being easily actuated or operated by the user.

The present invention has arisen to mitigate and/or obviate the afore-described disadvantages of the conventional converter hub assemblies or electric power sources or carrying cases.

### SUMMARY OF THE INVENTION

The primary objective of the present invention is to provide a portable power carrying case or electric power source or facility including an improved compact structure or configuration for being easily carried with the user and for being easily actuated or operated by the user.

In accordance with one aspect of the invention, there is provided a power carrying case comprising a housing including an input terminal, and at least one output terminal, an electric charging circuit disposed in the housing and electrically connected to the input terminal of the housing, the electric charging circuit including a battery electrically connected to the output terminal, an electric cable for electrically connecting to the input terminal of the housing, and at least one electric charging mechanism electrically connected to the battery for allowing the power carrying case to be easily carried with the user and for being easily actuated or operated by the user to supply the electric power or energy to various electric facilities or appliances, particularly suitable for being used outdoors.

The housing includes a channel formed therein for receiving and engaging with the electric charging mechanism. The housing includes a connector engaged in the channel of the housing and electrically connected to the battery, and the electric charging mechanism includes a coupler for engaging with the connector of the housing and for electrically connecting or coupling to the connector of the housing and for allowing the electric charging mechanism to supply an electric power or energy to the battery or the like.

The housing includes a cover attached to the housing for covering and shielding the electric charging mechanism and the channel of the housing and for preventing the dirt or containment from entering into the electric charging mechanism. The housing includes one or more handles disposed on the edges and provided for contacting or engaging with the supporting surface or the supporting ground and for spacing the housing from the supporting surface or the supporting ground and for allowing the handles to be grasped and held by the users easily.

The electric charging circuit includes an AC/DC detecting circuit electrically connected to the input terminal, an AC/DC convertor electrically connected to the AC/DC detecting circuit, and the AC/DC convertor is electrically connected to the battery for converting an alternative current electric power or energy to a direct current electric power or energy. A wireless charging mechanism may further be provided and electrically connected to the battery for allowing the battery to be charged wirelessly.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view illustrating the operation of a power carrying case in accordance with the present invention;

FIG. 2 is a perspective view of the power carrying case, as seen from the front portion of the power carrying case;

FIG. 3 is another perspective view similar to FIG. 2, illustrating the operation of the power carrying case;

FIG. 4 is a further perspective view of the power carrying case, as seen from the rear portion of the power carrying case;

FIG. 5 is another partial exploded view illustrating the parts or elements of the power carrying case;

FIG. 6 is an enlarged partial exploded view of the power carrying case;

FIG. 7 is a block diagram of the power carrying case; and

FIGS. 8, 9, 10 are side plan schematic views illustrating the operation of the power carrying case.

### DETAILED DESCRIPTION OF THE PREFERRED EMBODIMENT

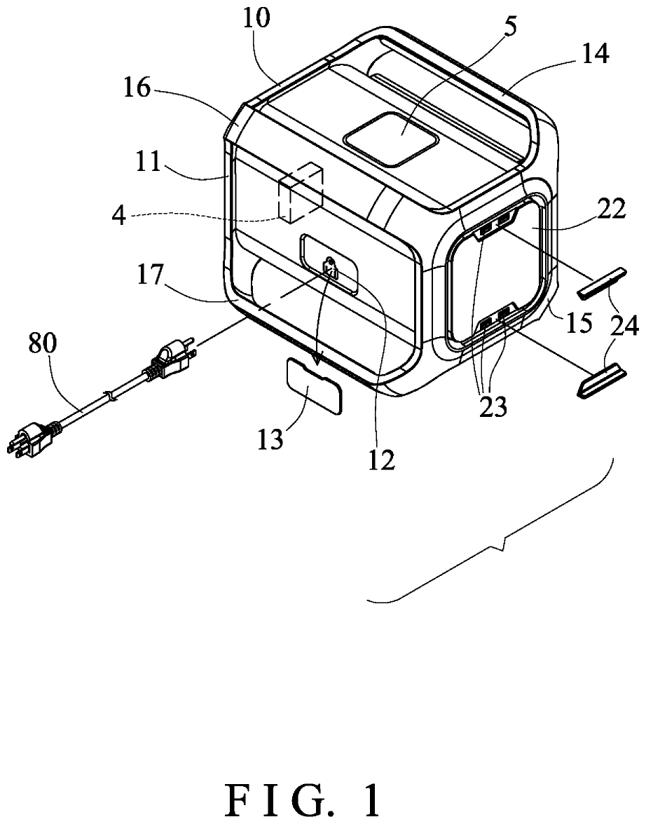

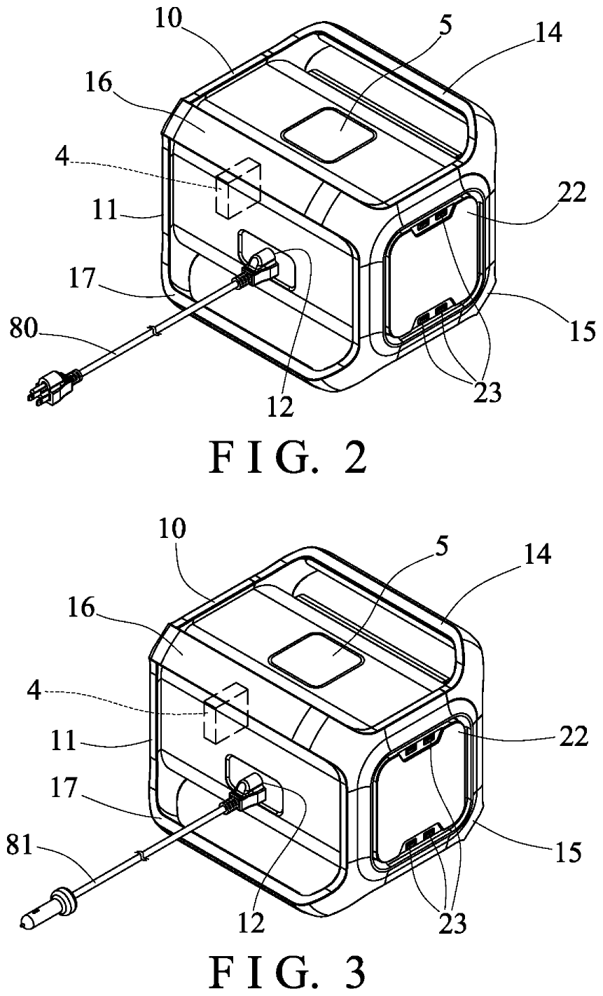

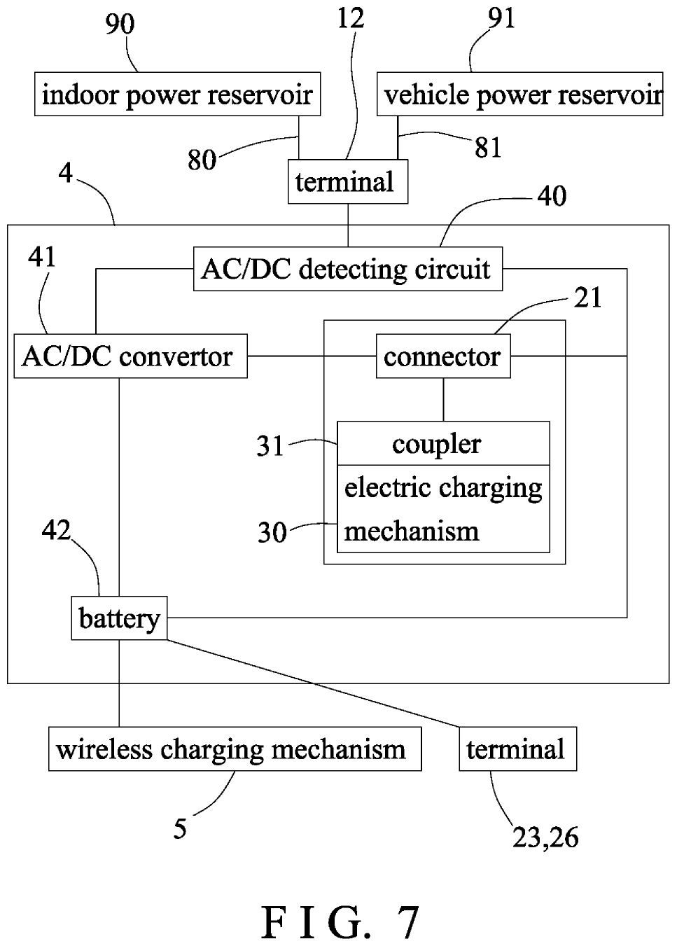

Referring to the drawings, and initially to FIGS. 1-5, an electric power source or facility or portable power carrying case in accordance with the present invention comprises an outer container or housing 10 including a substantially parallelepiped structure or configuration, and including a front portion 11 having an input socket or terminal 12 for electrically connecting or coupling to various electrical facilities or implements or power suppliers, for example, as shown in FIGS. 2 and 7, the input terminal 12 may be electrically connected or coupled to the indoor electric power source 90 with an indoor electric cable 80, for receiving or obtaining the electric power or energy from the indoor electric power reservoir or the like selectively, and may also be electrically connected or coupled to the vehicle power source 91 with a vehicle electric cable 81, for receiving or obtaining the electric power from the vehicle power reservoir or the like selectively.

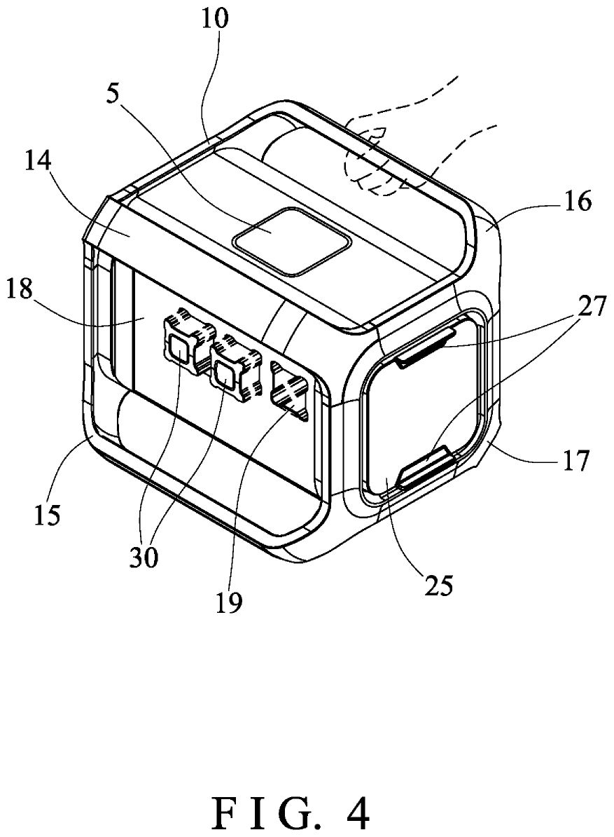

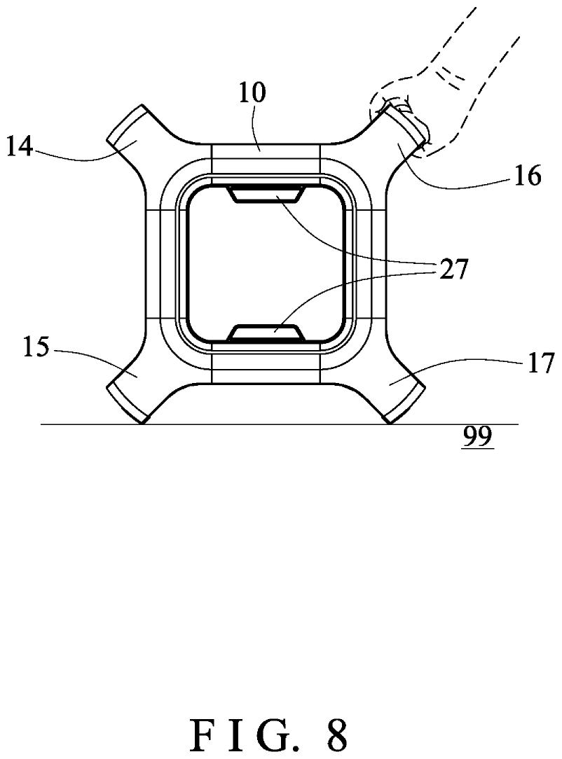

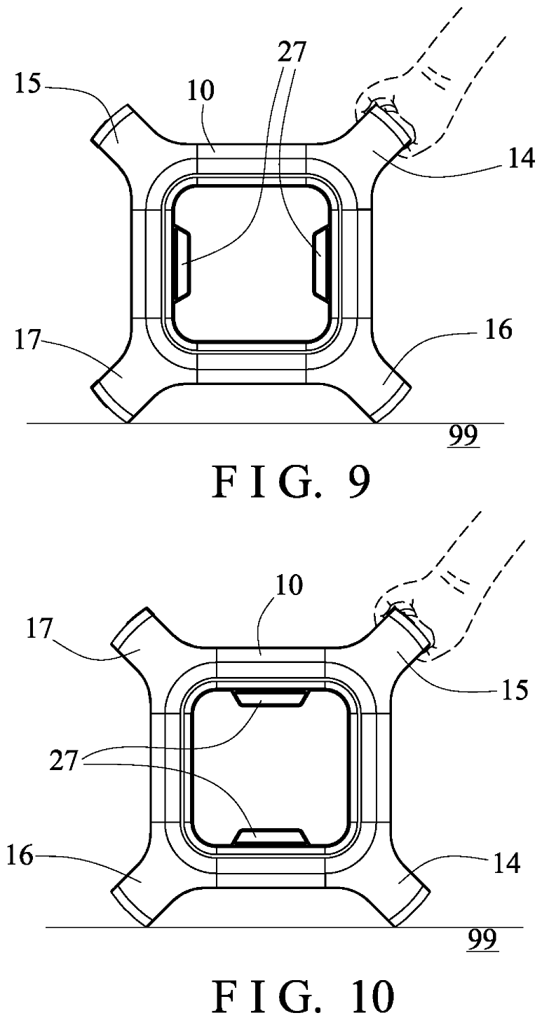

The housing 10 includes a cap or lid 13 (FIG. 1) attached or engaged onto the front portion 11 of the housing 10 for covering or shielding the input terminal 12 and the like, and for preventing the dirt or containment from entering into the input terminal 12. The housing 10 further includes one or more (such as four) handles 14, 15, 16, 17 formed or provided on the four corner areas or four edges thereof and parallel to each other for being grasped and held by the user. As shown in FIGS. 8-10, any two of the handles 14, 15, 16, 17 may be provided for contacting or engaging with the supporting surface or the supporting ground 99, and either of the handles 14, 15, 16, 17 may be provided for being grasped and held by the user easily and quickly and readily. The housing 10 includes a rear portion 18 having one or more openings or channels 19 formed therein (FIGS. 4-6), and a lid or cover 20 attached or engaged onto the rear portion 18 of the housing 10 for covering or shielding the channels 19 of the housing 10.

The housing 10 further includes a terminal or connector 21 (FIG. 6) disposed or engaged in each of the channels 19 of the housing 10, the channels 19 of the housing 10 may be provided for receiving or engaging with the electric charging mechanisms 30 respectively, in which the electric charging mechanisms 30 each include a terminal or coupler 31 (FIG. 6) formed or provided therein for selectively engaging with the connector 21 of the housing 10 (FIG. 7). As shown in FIGS. 1-3, an electric charging circuit 4 is disposed or engaged in or attached to the housing 10, and as shown in FIG. 7, the electric charging circuit 4 includes an alternate current (AC) and direct current (DC) judging or detecting circuit 40 electrically connected or coupled to the input terminal 12 for receiving or obtaining the electric power or energy from the indoor electric power reservoir or the vehicle power reservoir or the like selectively.

The electric charging circuit 4 further includes an alternate current (AC) and direct current (DC) convertor 41 electrically connected or coupled to the AC/DC detecting circuit 40, and an electric power source or reservoir or battery 42 is electrically connected or coupled to the AC/DC convertor 41 for receiving or obtaining the electric power or energy from the AC/DC convertor 41. The input terminal 12 of the housing 10 is also electrically connected or coupled to the battery 42 for supplying the electric power or energy from the electric charging mechanisms 30 to the battery 42 selectively. As shown in FIGS. 1-5, a wireless charging mechanism 5 may further be provided and disposed or engaged in or attached to the housing 10, and electrically connected or coupled to the battery 42 for further supplying the electric power or energy to the battery 42 selectively.

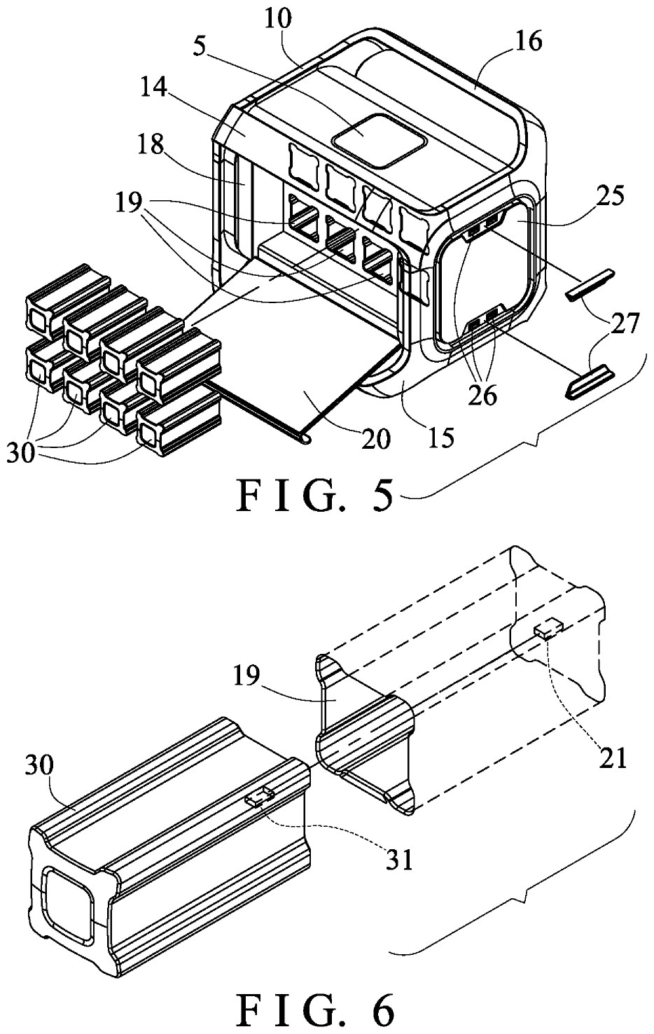

As shown in FIGS. 1-3 and 5, the housing 10 includes one or right or first side portion 22 having one or more sockets or couplers or output terminals 23 formed or provided therein and electrically connected or coupled to the battery 42 (FIG. 7) for outputting the electric power or energy or the like, and may further include one or more covers or caps 24 (FIG. 1) attached or engaged onto the right or first side portion 22 of the housing 10 for covering or shielding the output terminals 23 of the housing 10. The housing 10 further includes another or left or second side portion 25 (FIGS. 4-5) having one or more sockets or couplers or output terminals 26 formed or provided therein and electrically connected or coupled to the battery 42 (FIG. 7) for outputting the electric power or energy or the like, and may further include one or more covers or caps 27 attached or engaged onto the left or second side portion 25 of the housing 10 for covering or shielding the output terminals 26 of the housing 10.

In operation, as shown in FIGS. 1-3 and 7, the input terminal 12 of the housing 10 may be electrically connected or coupled to the indoor electric power source 90 with the indoor electric cable 80, or may be electrically connected or coupled to the vehicle power source 91 with the vehicle electric cable 81, for receiving or obtaining the electric power from the vehicle power reservoir or the like selectively, and for supplying the electric power or energy to the battery 42 selectively. The wireless charging mechanism 5 may also be provided and electrically connected or coupled to the battery 42 for further supplying the electric power or energy to the battery 42 selectively. The electric charging mechanisms 30 may also be provided and electrically connected or coupled to the battery 42 for further supplying the electric power or energy to the battery 42 selectively.

Either of the output terminals 23, 26 of the housing 10 may be provided and electrically connected or coupled to various electrical facilities or implements (not illustrated) with plugs and cables or the like, and as shown in FIGS. 4 and 8-10, either of the handles 14, 15, 16, 17 may be grasped and held by the user easily and quickly and readily for allowing the portable power carrying case to be easily carried with the user and to be easily actuated or operated by the user.

Accordingly, the portable power carrying case in accordance with the present invention includes an improved compact structure or configuration for being easily carried with the user and for being easily actuated or operated by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A power carrying case comprising:
a housing including an input terminal, and at least one output terminal,
an electric charging circuit disposed in said housing and electrically connected to said input terminal of said housing, said electric charging circuit including a battery electrically connected to said at least one output terminal,
an electric cable for electrically connecting to said input terminal of said housing, and
at least one electric charging mechanism electrically connected to said battery.

2. The power carrying case as claimed in claim 1, wherein said housing includes a channel formed therein for receiving and engaging with said at least one electric charging mechanism.

3. The power carrying case as claimed in claim 2, wherein said housing includes a connector engaged in said channel of said housing and electrically connected to said battery, and said at least one electric charging mechanism includes a coupler for engaging with said connector of said housing.

4. The power carrying case as claimed in claim 2, wherein said housing includes a cover attached to said housing for covering and shielding said at least one electric charging mechanism and said channel of said housing.

5. The power carrying case as claimed in claim 1, wherein said housing includes at least one handle for being grasped and held by a user.

6. The power carrying case as claimed in claim 1, wherein said housing includes four edges, and four handles provided on said edges respectively for being grasped and held by a user.

7. The power carrying case as claimed in claim 1, wherein said electric charging circuit includes an AC/DC detecting circuit electrically connected to said input terminal, an AC/DC convertor electrically connected to said AC/DC detecting circuit, and said AC/DC convertor is electrically connected to said battery.

8. The power carrying case as claimed in claim 1 further comprising a wireless charging mechanism electrically connected to said battery.
